(19) United States
(12) Patent Application Publication
(10) Pub. No.: US 2025/0048529 A1
(43) Pub. Date: Feb. 6, 2025

(54) CERAMIC ENHANCED TRAVELLING WAVE ACCELERATOR STRUCTURE

(71) Applicant: Triad National Security, LLC, Los Alamos, NM (US)

(72) Inventors: Haoran XU, Los Alamos, NM (US); Leanne Delma DUFFY, Los Alamos, NM (US); Janardan UPADHYAY, Los Alamos, NM (US); Kevin Aaron SHIPMAN, Los Alamos, NM (US)

(21) Appl. No.: 18/779,986

(22) Filed: Jul. 22, 2024

Related U.S. Application Data
(60) Provisional application No. 63/517,675, filed on Aug. 4, 2023.

(51) Int. Cl. H05H 7/22; H05H 9/02

(52) U.S. Cl. CPC H05H 7/22; H05H 9/02; H05H 2007/227

(57) ABSTRACT

A linear accelerator is provided. The linear accelerator includes a plurality of cells. Each cell includes an outer ring comprising a first material; an inner ring, comprising a second material, and at least one end plate in physical contact with the outer ring and the inner ring and having beam aperture therethrough. The first material is substantially electrically conductive and the second material is substantially not electrically conductive. The inner ring is centered within the outer ring. The beam aperture of each cell of the plurality of cells are aligned to define a beam path.

### CROSS-REFERENCE TO RELATED APPLICATIONS

This application claims priority to U.S. Application No. 63/517,675, filed Aug. 4, 2023, the content of which is incorporated herein by reference in its entirety.

### STATEMENT REGARDING GOVERNMENT SUPPORT

This invention was made with U.S. Government support under Agreement No. 89233218CNA00000 awarded by the Department of Energy to Triad National Security, LLC. The government has certain rights in the invention.

### FIELD

Various embodiments relate to a linear accelerator (linac) configured for accelerating charged particles. For example, various embodiments relate to a traveling wave charged particle accelerator.

### BACKGROUND

Charged particle accelerators are used to accelerate charged particles for various purposes, including X-ray radiography, radiation therapy, X-ray scanners, waste treatment, and others. Two types of radiofrequency (RF) accelerators are usually used: standing-wave RF accelerators and traveling-wave RF accelerators. Standing-wave charged particle accelerators may be configured to have a high time-dependent shunt impedance such that for a given amount of radiofrequency power provided to the accelerator, the accelerator produces a higher-energy beam of charged particles compared to an accelerator with lower time-dependent shunt impedance. However, these accelerators have an RF filling time that is quite long, resulting in long wait times between when the RF power is turned on and when the beam of charged particles can be injected into the accelerator. Conventional (e.g., entirely metallic) traveling-wave accelerators may be configured to have shorter RF filling times, but they tend to have smaller time-dependent shunt impedances. Through applied effort, ingenuity, and innovation many deficiencies of prior charged particle accelerators have been solved by developing solutions that are structured in accordance with the embodiments of the present invention, many examples of which are described in detail herein.

### SUMMARY

Various embodiments provide a linear accelerator (linac) configured for accelerating charged particles. In various embodiments, the linac comprises a plurality of cells that are aligned along an axis of the linac. Each cell, in embodiments, includes an outer ring, an inner ring centered within the outer ring, and a pair of end plates, where each endplate may be shared by neighboring cells (except if the cell is a first or last one in the series). The end plate includes an aperture therethrough such that when the plurality of cells are aligned, the apertures define a straight path through the linac along which charged particles may be accelerated. The outer ring comprises a first material, the first material comprising a metal, such as copper, that is highly electrically conductive. The inner ring comprises a second material, such as a high dielectric constant, low loss tangent ceramic for example, that is an electrical insulator. In various embodiments, the aligned plurality of cells are configured to support a higher-order transverse magnetic RF mode, such as a TM₀₂-like mode, for example. In various embodiments, the end plates include coupling slots configured to enable RF power to propagate through the outer cavities of neighboring cells.

According to a first aspect, a linear accelerator is provided. In an example embodiment, the linear accelerator includes a plurality of cells. Each cell includes an outer ring, an inner ring centered within the outer ring; and an end plate. The end plate is in physical contact with the outer ring and the inner ring and has a beam aperture therethrough. The outer ring comprises a first material that is an electrically conducting material. The inner ring comprises a second material that is different from the first material. The second material is an electrically insulating material. The beam aperture of each cell of the plurality of cells are aligned to define a beam path.

According to another aspect, a linear accelerator is provided. In an example embodiment, the linear accelerator includes a plurality of cells. Each cell includes an outer ring, wherein the outer ring comprises a first material; an inner ring, wherein the inner ring (a) comprises a second material that is substantially not conductive and (b) is centered within the outer ring; and an end plate. The end plate in physical contact with the outer ring and the inner ring and has a beam aperture therethrough. The beam aperture of each cell of the plurality of cells are aligned to define a beam path and the aligned plurality of cells are configured to support a higher order transverse magnetic mode of a radiofrequency signal.

### BRIEF DESCRIPTION OF THE DRAWINGS

Having thus described certain example embodiments in general terms, reference will hereinafter be made to the accompanying drawings, which are not necessarily drawn to scale, and wherein:

FIG. 1A provides a cross-sectional view of an example cell of a traveling wave accelerator cell of a linac, in accordance with an example embodiment;

FIG. 1B provides an illustration of the longitudinal electric field distribution in the example cell shown in FIG. 1A during operation of the linac, in accordance with an example embodiment;

FIG. 1C provides an illustration of the magnetic field magnitude distribution in the example cell shown in FIG. 1A during operation of the linac, in accordance with an example embodiment;

FIG. 2 provides a front view of an example end plate, in accordance with an example embodiment;

FIG. 3 provides an exploded view of an example assembly involving two cells in the traveling wave accelerator structure, in accordance with an example embodiment;

FIG. 4 provides a partial cut-away view of an example traveling wave accelerator structure and the normalized accelerating field distribution within the traveling wave accelerator structure during operation thereof, in accordance with an example embodiment; and

FIG. 5 provides a perspective view of an example linac system including the example traveling wave accelerator structure (shown with a partial cut-away), in accordance with an example embodiment.

FIG. 6 provides a perspective view of an example radio frequency (RF) coupler, in accordance with an example embodiment.

### DETAILED DESCRIPTION OF SOME EXAMPLE EMBODIMENTS

### I. General Overview

Embodiments provide for a traveling wave (TW) accelerator structure configured for accelerating charged particles, such as electrons, protons, and/or the like. The TW accelerator structure concurrently achieves both high time-dependent shunt impedance (e.g., about 162 MO/m) and high group velocity (e.g., about 3.1% speed of light) at a frequency of 5.712 GHz for accelerating an ultra-relativistic charged particle beam. Higher shunt impedance allows the accelerator to produce higher-energy beams with the same amount of RF power provided. Higher group velocity leads to fast filling of the RF waves in the accelerator, shortening the wait time between the RF turn-on and the beam injection, amongst various advantages, saving significant amounts of RF power, in each RF pulse. These two features have been thought to be mutually exclusive in all-metallic normal conducting RF (NCRF) accelerator structures. For example, previously developed TW accelerators with comparable group velocity had a shunt impedance more than 50% lower than that presently realized with embodiments. Achieving comparable shunt impedance previously resulted in the RF filling time being one order of magnitude longer, resulting in remarkable RF power waste per RF pulse. Unlike other accelerators, e.g., conventional accelerators, embodiments of the present invention utilize dielectric materials, in lieu of (or in addition to) metallic materials.

The basic unit-cell geometry of embodiments of the present TW accelerator structure comprises an inner ceramic tube or ring inserted inside a cylindrical, metallic pillbox (e.g., comprising an outer ring capped by end plates). The ceramic tube or ring may separate the accelerator cell into two concentric regions. The inner region may be used for establishing accelerating fields, while the outer region may be used for accomplishing cell-to-cell RF coupling. Confining the high-electric-field region of the accelerating mode in each cell in the embodiments of the present TW accelerator structure is achieved by the ceramic ring, as opposed to by a metallic, cylindrical sidewall as in a conventional, metallic accelerator. The embodiment design informs at least partly the ability to achieve high shunt impedance concurrent with high group velocity. The ceramic tube or ring induces zero ohmic power dissipation, and the dielectric volumetric loss is kept at a very low level. The high group velocity may be realized by the cell-to-cell RF coupling achieved through oversized coupling slots in the outer region, located at radial positions beyond the confinement of the ceramic tube. In other words, the ceramic tube provides optimized RF field distribution as well as separation in each unit cell of the TW accelerator structure, achieving low-loss accelerating field confinement in the inner region, while allowing sufficient cell-to-cell coupling in the outer region.

Practical applications of the TW accelerator structure include a compact linear accelerator, or linac. In this context, realized advantages of some embodiments include enhancement of RF power utilization efficiency, achieved in two ways. First, higher shunt impedance allows accelerating charged particle beams to reach a higher energy, with the same amount of RF power provided (e.g., compared to an accelerator having lower shunt impedance). Second, RF power utilization efficiency is enhanced by presenting a very short RF filling time; this shortens the idle time of the accelerator between the turn-on of the RF pulse and the injection of the beam into the accelerator. Therefore, in these embodiments, very little RF power is dissipated without being used to accelerate the beam. Meanwhile, the short RF filling time also addresses the application need to maximize the duty factor of the accelerated beam. Shorter RF filling time allows an earlier turn-on of the accelerated beam for each RF pulse, maximizing the beam time. In various embodiments, the TW accelerator structure has a shunt impedance greater than 150 MΩ/m (e.g., 162 MΩ/m, in an example embodiment operating at 5.712 GHz) and a RF wave filling time of less than 50 nanoseconds (e.g., 45 nanoseconds, in an example embodiment operating at 5.712 GHz).

Additional applications in which embodiment may be used include in the medical field, for example, for providing X-ray, electron, or proton beams for radiation therapy or the like. Indeed, many applications and modifications and other embodiments of the invention set forth herein will come to mind to one skilled in the art to which these inventions pertain having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation. In this regard, it should be understood that the invention may be embodied in many different forms and should not be construed as limited to the embodiments set forth herein; rather, these embodiments are provided so that this disclosure will satisfy applicable legal requirements.

### II. Example Cell

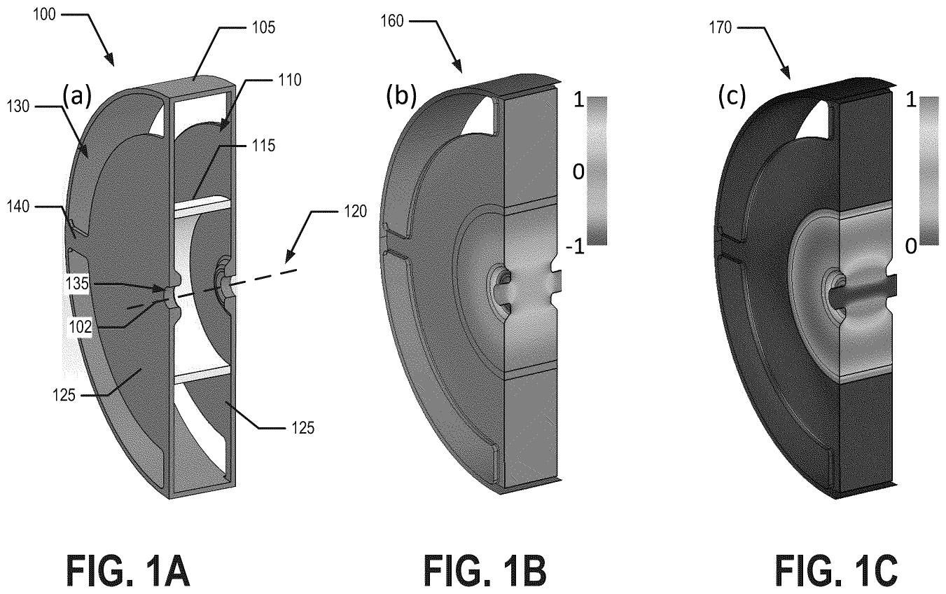

FIG. 1A provides a perspective cross-sectional view of an example cell 100 of an example TW accelerator structure. In various embodiments, a cell 100 defines a pillbox cavity. The example cell 100 includes an outer ring 105 and an inner ring 115 and at least one end plate 125. The outer ring 105, the inner ring 115, and the at least one end plate 125 define an outer cavity 110 of the cell. The inner ring 115 and the at least one end plate 125 define an inner cavity 120 of the cell.

In various embodiments, the outer ring 105 comprises a first material. In various embodiments, the first material is a metal and/or electrically conductive material. For example, in an example embodiment, the first material is copper. The outer ring may include permanent magnets in some embodiments.

In an example embodiment, the outer ring 105 is machined out of the first material. In another example embodiment, the outer ring 105 is formed by a core ring that is wrapped and/or coated in the first material. For example, the outer ring 105 may comprise a non-conductive (e.g., plastic and/or the like) core or a permanent magnetic material core that is coated and/or wrapped in the first material. The coating and/or wrapping of the first material is at least as thick as two skin depths of the RF power signal in the first material.

In various embodiments, the diameter of the outer ring is in range of from about 50 mm to about 150 mm. In some embodiments, the outer ring may have a diameter that is smaller than about 50 mm or larger than about 150 mm, as appropriate for the application.

In an example embodiment, the outer ring 105 comprises a permanent magnet. In an example embodiment, the outer ring 105 comprises a permanent magnet that is wrapped or coated with the first material. For example, in an example embodiment, the outer ring 105 comprises a ring of permanent magnet material that is covered and/or coated with the first material. For example, the permanent magnet is configured to control the focus of a charge particle beam accelerated by the TW accelerator structure, in an example embodiment.

In an example embodiment, outer ring 105 is machined from the first material (e.g., a conductive material like copper) and magnetic components (e.g., components comprising permanent magnetic material) may be secured to one or more positions on the exterior surface of the outer ring 105. In an example embodiment, the outer ring 105 may include a cooling fluid path configured for a cooling fluid to be circulated and/or flowed therethrough.

In various embodiments, the outer ring 105 is a circular ring having a finite height along an axis 102 defined along the center of the ring. For example, the outer ring 105 is a hollow cylinder and/or a cylindrical wall. In various embodiments, the height of the outer ring 105 along the cell axis 102 is less than the diameter of the outer ring 105.

In various embodiments, the height of the outer ring 105 is determined based on a wavelength or frequency of the RF power signal to be applied to the TW accelerator structure comprising the cell 100. For example, the height of the outer ring 105 is determined to be a particular fraction of the wavelength of the RF power signal to be applied to the TW accelerator to operate the TW accelerator structure. For example, the TW accelerator structure is configured such that the phase of the RF power signal will advance a particular amount across each cell of the TW accelerator structure, in various embodiments. In an example embodiment, the TW accelerator structure is configured such that the phase of the RF power signal will advance 2π/3 radians, or 120 degrees, across each cell 100 of the TW accelerator structure. In such an embodiment, the height of the outer ring 105 is configured to be ⅓ of the wavelength of the RF power signal.

In various embodiments, the inner ring 115 comprises a second material. In various embodiments, the second material is a substantially non-conducting material. For example, in some embodiments, the second material may be an electrical insulator. In various embodiments, the second material and/or the inner ring 115 has a dielectric constant that is equal to or greater than about 20. In various embodiments, the second material and/or the inner ring 115 has a dielectric constant of at least about 30. For example, in an example embodiment, the second material and/or the inner ring 115 has a dielectric constant of at least about 34.

In various embodiments, the second material and/or the inner ring 115 has a low loss tangent. For example, the loss tangent of the second material and/or the inner ring 115 may be less than 10⁻³, in various embodiments. For example, the loss tangent of the second material and/or the inner ring 115 may be less than 5×10⁻⁴, in various embodiments. In other example embodiments, the loss tangent of the second material and/or the inner ring 115 is less than 2.5×10⁻⁴.

In various embodiments, the second material is a ceramic material. For example, the second material may in some embodiments be a ceramic material comprising a titanate, such as barium titanate.

In various embodiments, the inner ring 115 has a diameter in a range of about 15 mm to about 100 mm. In an example embodiment, the outer ring 105 has an outer diameter of about 100 mm and the inner ring 115 has an outer diameter of about 40 to about 45 mm and an inner diameter of about 35 to about 40 mm. In various embodiments, the inner and/or outer diameter of the inner ring 115 is configured and/or designed such that the inner ring 115 experiences a minimized electric field magnitude for the mode of the RF power signal to be applied to the TW accelerator structure (e.g., higher order mode such as TM₀₂ mode, TM₀₂-like mode, and/or the like). This results in a reduced risk of dielectric breakdown and nonlinear dielectric property deviation behavior of the inner ring 115.

In various embodiments, the height of the inner ring 115 along the cell axis 102 is substantially the same as the height of the outer ring 105. For example, in various embodiments, the inner ring 115 is held in position via clamping of the inner ring 115 between two end plates 125 that are coupled to the outer ring 105.

In an example embodiment, one or both end surfaces 116 of the inner ring 115 is coated with a conductive material, such as a metal (e.g., copper). For example, in embodiments both end surfaces 116 of the inner ring 115 are coated in a layer of copper (or other conductive material) that may be approximately 10 μm thick.

In an example embodiment, the inner ring 115 may serve as a vacuum envelope such that pressure in the region within the inner ring 115 is different from the pressure within the region between the inner ring 115 and the outer ring 105. For example, the region between the inner ring 115 and the outer ring 105 may be at, below, or above atmospheric pressure, in various scenarios. In some embodiments, the region between the inner ring 115 and the outer ring 105 may be filled with air or another gas. For example, the gas could be flowed along the TW accelerator structure to provide cooling for the structure.

In various embodiments, the end plate 125 comprises a third material. In various embodiments, the third material may be a substantially electrically conductive material and/or ferromagnetic or paramagnetic material. For example, in embodiments, the end plate 125 may be made of materials that include copper. In an example embodiment, the end plate 125 comprises a steel sheet that is coated with copper. For example, in some embodiments the end plates may be made from a ferrite steel such as 1006, 1008, or 1010 steel.

In an example embodiment, the end plate 125 has a diameter in a range of about 50 mm to about 150 mm. For example, in various embodiments, the outer ring 105 and the end plate 125 have approximately the same diameter. In an example embodiment, the end plate 125 has a thickness of approximately 1 mm.

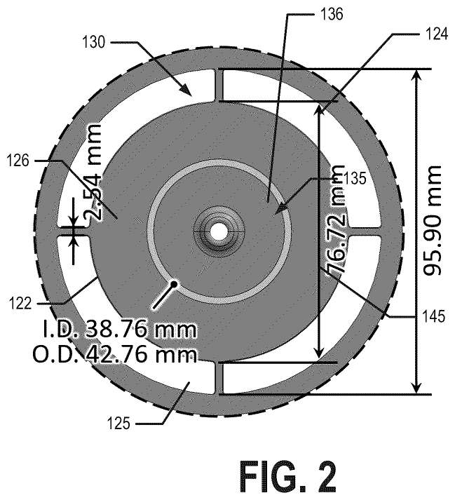

FIG. 2 provides a front view of an example end plate 125. In various embodiments, the end plate 125 comprises an aperture 135 therethrough. The aperture 135 provides a path for the charged particle beam to pass through the end plate 125. In various embodiments, the aperture 135 has a radius in a range of 2-4 mm. In an example embodiment, the aperture 135 has a radius of about 2.6 mm.

In an example embodiment, end plate comprises a domed central portion and/or nose cone 136 and the aperture 135 is formed through the domed central portion and/or nose cone 136. For example, the domed central portion and/or nose cone 136 is an annular protrusion about the aperture 135. The domed central portion and/or nose cone 136 is configured to increase the accelerator cell shunt impedance. For example, the size and/or shape of the domed central portion and/or nose cone 136 is configured and/or optimized for maximizing the time-dependent shunt impedance of the accelerator cell 100.

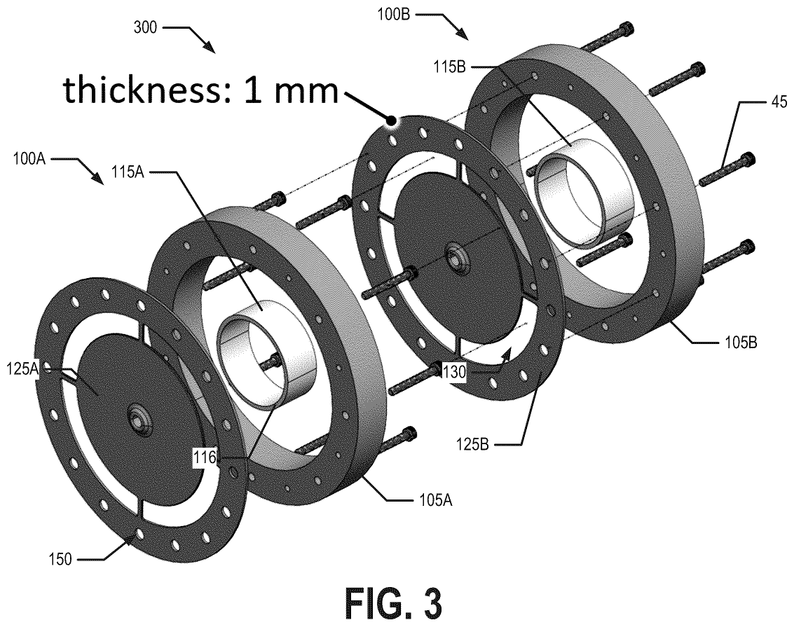

In various embodiments, the end plate 125 includes coupling slots 130. In various embodiments, the coupling slots 130 are openings in a respective end plate 125 that enables coupling of the electromagnetic field in one cell 100 with the electromagnetic field in a neighboring cell. For example, the coupling slots 130 enable coupling of the electromagnetic field in an outer cavity 110 of one cell 100 with the outer cavity of an adjacent and/or immediately neighboring cell. For example, as shown in FIG. 3, the coupling slots 130 formed in end plate 125B enables coupling of the electromagnetic field within the outer cavity 110 of the first cell 100A and the outer cavity of the second cell 100B through the end plate 125B.

In the illustrated end plate 125 shown in FIG. 2, the end plate 125 comprises a plurality of coupling slots 130 that each form an arc around the end plate 125. For example, in various embodiments, the end plate comprises an annular outer plate portion 122 and an inner plate portion 124 that are connected to one another via links 126. The coupling slots 130 are disposed between the annular outer plate portion 122 and the inner plate portion 124. The aperture 135 extends through the inner plate portion 124.

In an example embodiment, the inner plate portion 124 comprises a groove 145. In various embodiments, the groove 145 is configured to engage the inner ring 115. For example, the groove may have a thickness in the plane of the end plate 125 that is substantially the same as the thickness of the inner ring 115. In these embodiments, the edges of the groove 145 are configured to engage the end of the inner ring 115 such that the inner ring 115 is seated at least partially within the groove 145. In various embodiments, the groove 145 may be shallow such that the depth of the groove is substantially less than about 0.25 mm. Some embodiments do not include a groove 145 in the end plate 125.

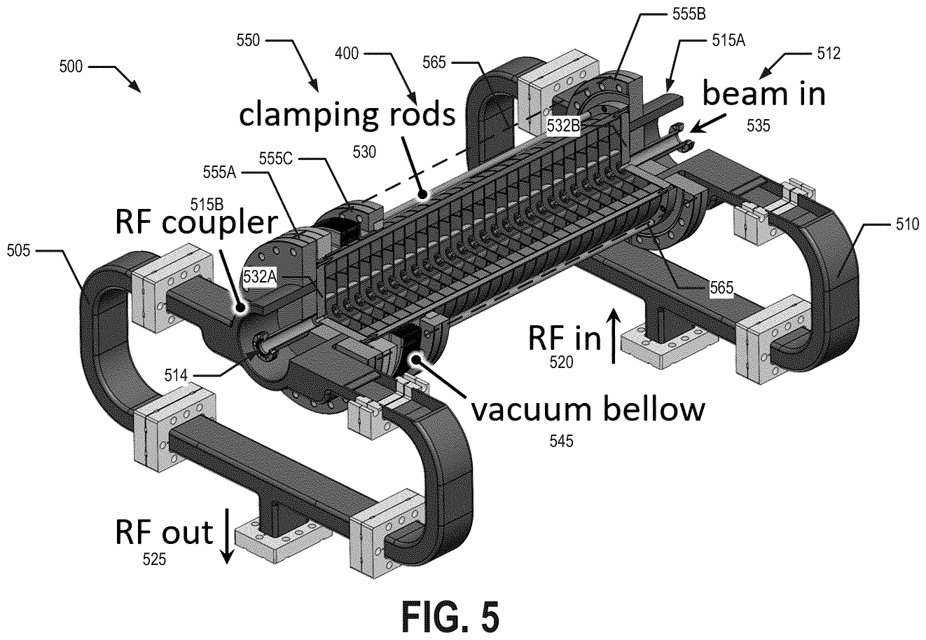

In various embodiments, the annular outer plate portion 122 comprises fastener holes 150, as shown in FIG. 3. For example, the outer ring 105 and the end plates 125 may include fastener holes 150 configured for receiving fasteners 45 (e.g., screws, bolts, clamping rods, and/or the like) therethrough. The fasteners 45 are configured to secure the at least one end plate 125 to outer ring 105 such that frictional and/or clamping force is asserted on the ends of the inner ring 115 by the end plates 125 such that the inner ring 115 maintains a centered position within the cell 100. In some embodiments, clamping rods 530 are used in place of and/or in addition to the fasteners 45 to secure and/or clamp the overall TW accelerator structure comprising a plurality of cells 100. As described below, rods 530 (FIG. 5) provide additional clamping force on the overall structure that aides in maintain the inner ring 115 in place. For example, the axis of the cylinder of the outer ring 105 is aligned with the axis of the cylinder of the inner ring 115, which are both aligned with the aperture(s) 135 of the end plate(s) 125 so as to commonly define the cell axis 102.

FIG. 1B illustrates the longitudinal electrical field distribution 160 within the cell 100 during operation of a TW accelerator structure comprising the cell 100. As shown in FIG. 1B, the amplitude of the longitudinal electrical field is approximately zero in the outer cavity 110 of the cell 100. FIG. 1C illustrates the magnetic field magnitude distribution 170 within the cell 100 during operation of a TW accelerator structure including the cell 100. The magnetic field amplitude in the outer cavity 110 is generally small. For example, the accelerating electromagnetic field is confined within inner cavity 120.

### III. Example TW Accelerating Structure

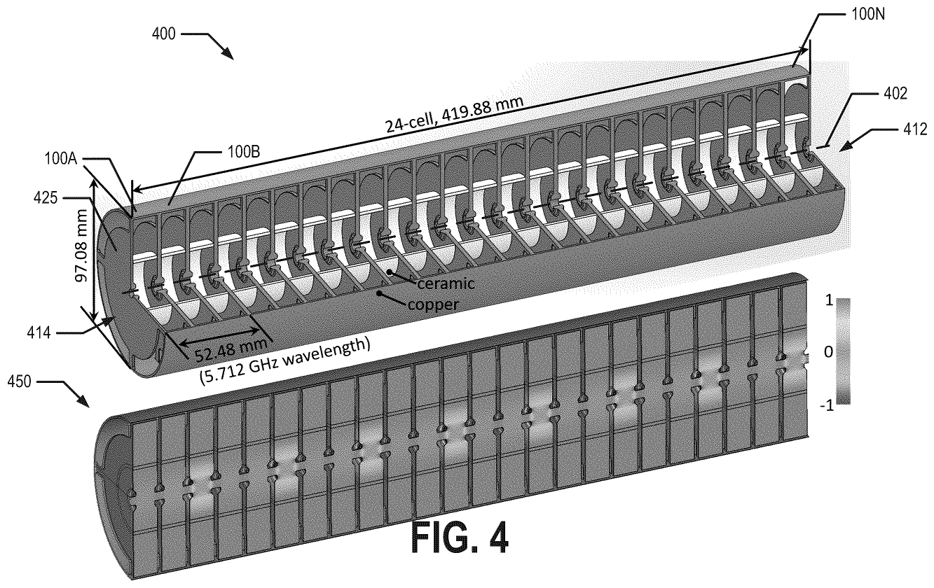

FIG. 3 illustrates an exploded view of an example TW accelerator structure 300 comprising two cells 100A, 100B according to an embodiment. FIG. 4 provides a partial cutaway view of a TW accelerator structure 400 including a plurality of cells 100A, 100B, . . . 100N. For example, the illustrated example TW accelerator structure 400 includes twenty-four cells 100. FIG. 4 further illustrates the normalized accelerating field distribution 450 during operation of the TW accelerator structure 400 in a 2π/3 operating mode (e.g., where the TW accelerator structure 400 and the RF power signal are configured such that the phase of the RF power signal advances 2π/3 radians, or 120 degrees, across each cell 100 of the TW accelerator structure 400). As shown for individual cells by FIGS. 1B and 1C, the accelerating electromagnetic field is confined within the inner cavities 120 of the cells 100 by the respective inner rings 115.

In various embodiments, the plurality of cells of the TW accelerator structure are aligned such that the respective cell axis 102 of each cell is aligned to define an accelerator axis 402. For example, the respective apertures 135 of each of the end plates 125 of each of the cells are aligned to define a beam path along the accelerator axis 402. The components of the plurality of cells are clamped together (e.g., by fasteners 45) such that a TW accelerator structure is formed including alternating end plates 125 and pairs of concentric rings (e.g., an outer ring 105 and an inner ring 115 centered therein).

In various embodiments, the TW accelerator structure 400 extends between a first end 412 and a second end 414. The beam path defined along the accelerator axis 402 by the aligned apertures 135 extends from the first end 412 of the TW accelerator structure 400 to the second end 414 of the TW accelerator structure 400. For example, the TW accelerator structure 400 is configured such that a charged particle beam may be injected into the TW accelerator structure 400 along the beam path at the first end 412. The particles of the injected charge particle beam have a first energy and are generally/substantially collimated along the beam path. The charged particle beam exits the TW accelerator structure 400 via an aperture 135 along the beam path at the second end 414. The particles of the charged particle beam exit the TW accelerator structure 400 with a second energy, with the charged particle beam still generally/substantially collimated along the beam path and/or accelerator axis 402. The second energy is different from (e.g., not equal to) the first energy. For example, in some instances the first energy is higher than the first energy.

In various embodiments, the end plates 125 disposed on the first end 412 and the second end 414 of the TW accelerator structure 400 are closure end plates 425. The closure end plates 425 include respective apertures 135, the slots 130 allow the RF power to be coupled from the RF coupler to the accelerating structure 400. For example, the input RF power enters the TW accelerator structure 400 via the coupling slots 130 of the endplate 425 at the first end 412. The RF power propagates from the first end 412 to the second end 414 through each cell 100. Finally, the remaining, unused, or spent RF power exits the structure 400 from the coupling slots 130 of the endplate at the second end 414.

In various embodiments, the TW accelerator structure 400 is configured to have a RF power signal applied thereto. In various embodiments, the RF power signal is characterized by a frequency in a range of 500 MHz to 20 GHz. In some embodiments, the RF power signal is characterized by a frequency in the 2 to 6 GHz range. In an example embodiment, the RF power signal is characterized by a frequency of 5.712 GHz.

In various embodiments, the TW accelerator structure 400 is configured to operate in a 2π/3 mode such that the RF power signal propagating through the TW accelerator structure 400 evolves in phase by 2π/3 radians across each cell 100 of the TW accelerator structure 400.

### IV. Example Linac System

FIG. 5 provides a perspective view of an example linac system 500 including the TW accelerator structure 400. The outer rings 105 and the end plates 125 of the TW accelerator structure 400 are clamped together (with respective inner rings 115 disposed within the outer rings 105) via clamping rods 530. For example, the clamping rods 530 may be configured to pull terminal end plates 532A, 532B toward one another and the TW accelerator structure 400 is disposed between the two terminal end plates 532A, 532B, such that the outer rings 105, end plates 125, and the inner rings 115 are clamped together. In an example embodiment, the terminal endplates are formed of stainless steel, and/or another metal.

In various embodiments, at least a portion of the linac system 500 (e.g., the TW accelerator structure 400) is configured to be disposed within a vacuum system. For example, in various instances, the TW accelerator structure 400 is disposed within a vacuum chamber. For example, the vacuum chamber may be generally cylindrical and be defined by a chamber wall 565 that extends from a first vacuum flange 555A to a second vacuum flange 555B. For example, in various embodiments, the linac system 500 comprises a vacuum system 550 comprising the first vacuum flange 555A, the second vacuum flange 555B, vacuum bellows 545, chamber wall 565, and possibly other tubes and/or pumps configured to use the vacuum bellows 545 to generate and/or maintain a vacuum within the cylindrical space defined at least in part by the first vacuum flange 555A, the second vacuum flange 555B, and the chamber wall 565. The vacuum chamber 550 is shown in a cut-through manner such that the interior structure of the TW accelerator structure 400 may be viewed.

In an example embodiment, two vacuum chamber sections are defined by the vacuum system 550. For example, a first vacuum chamber section is defined by the first vacuum flange 555A, a third vacuum flange 555C, and a portion of the cylindrical chamber wall 565. A second vacuum chamber section is defined by the third vacuum flange 555C, a second vacuum flange 55B, and another portion of the cylindrical chamber wall 565.

In various embodiments, the vacuum chamber 550 is configured to surround the TW accelerator structure 400 and is configured to, with the coupled vacuum bellow 545, provide a high or ultra-high vacuum environment for the TW accelerator structure 400.

The linac system 500 further includes an input waveguide 510 configured to couple an RF power signal into the TW accelerator structure 400 and an output waveguide 505 configured to complete the RF power signal circuit. For example, the input waveguide 510 is a waveguide configured to guide an RF power signal in a conventional mode (e.g., in a TE₁₀ mode) from an RF source 520 to a first end 512 of the TW accelerator structure 400. For example, the input waveguide 510 may be a WR-187 waveguide. The RF power signal propagates through the TW accelerator structure 400. For example, the coupling slots 130 of the end plates 125 enable the electromagnetic field within the outer cavity 110 of one cell 100 to communicate with and/or couple with the electromagnetic field within the outer cavity of an adjacent or neighboring cell. This enables the RF power signal to propagate along the length of the TW accelerator structure 400 efficiently and quickly so as to provide a fast RF filling time.

The RF power signal is coupled from the input waveguide 510 to the TW accelerator structure 400 via an RF coupler 515A. The RF coupler 515A is configured to convert the mode of the RF power signal from a standard, lower order mode to be coupled to the TM₀₂-like mode in the accelerator structure 400. For example, the RF coupler 515A may be configured to prepare the mode of the RF power signal from the standard, lower order mode for coupling to the TM₀₂-like mode in the accelerator structure 400. For example, in various embodiments, the TW accelerator structure 400 is configured to support a higher order transverse magnetic TM mode, such as TM₀₂ mode or a TM₀₂-like mode. For example, in various embodiments, the diameter of the inner ring 515 is configured to confine a central portion of a TM₀₂-like mode and the coupling slots 130 are positioned and/or configured to enable an outer shell portion of a TM₀₂-like mode to pass therethrough. For example, the TM₀₂-like mode is a perturbation of a TM₀₂ mode, where the perturbation is caused by interaction with the coupling slots 130.

The linac system 500 further includes a second RF coupler 515B configured to couple the TW accelerator structure 400 to the output waveguide 505. For example, the output waveguide 505 couples the second end of the TW accelerator structure 400 to ground 525 and/or other RF circuit components. In an example embodiment, the second RF coupler 515B is configured to convert the RF power signal that propagated through the TW accelerator structure 400 from the higher order mode (e.g., TM₀₂ mode, TM₀₂-like mode, and/or the like) to a conventional lower order mode (i.e., TE₁₀). In an example embodiment, the TW accelerator structure 400 is configured to provide and/or operate an accelerating gradient of greater than 10 MV/m (e.g., 20 MV/m, in an example embodiment).

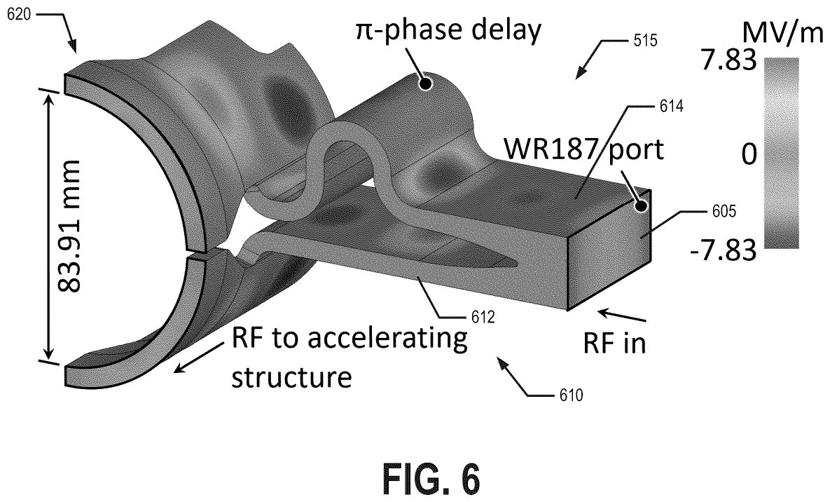

FIG. 6 illustrates an example RF coupler 515 configured to convert the RF power signal from the RF circuit components into a higher order TM mode, such as TM₀₂-like mode in the accelerating structure 400. The RF coupler 515 includes an input port 605 configured to receive an RF power signal in TE₁₀ mode of the RF power signal. In various embodiments, the input port 605 is a standard rectangular waveguide port (e.g., a WR187 port). The RF coupler 515 further includes a mode converter portion 610 configured to divide and transfer the RF power signal to portion 620. The application portion 620 provides the RF power signal processed by the portion 610, to the TW accelerator structure 400, which operates with a TM₀₂-like mode.

The mode converter portion 610 includes a direct transport section 612 and a delayed transport section 614. The RF power signal propagating through the direct transportation section 612 and the delayed transport section 614 are respective TE₁₀ modes. In various embodiments, the delayed transport section 614 is configured to delay a portion of the RF power signal transmitted thereby to be delayed in phase by 7L radians, or 180 degrees, with respect to the portion of the RF power signal transmitted by the direct transport section 612. The direct transport section 612 and the delayed transport section 614 are configured to provide portions of the RF power signal in parallel.

The application portion 620 is curved with a radius of curvature that is smaller than that of the outer ring 105. In various embodiments, the application portion 620 is configured to be in electrical contact with the accelerator cell at either end of the TW accelerator structure 400 (e.g., adjacent and/or next to the RF coupler 515A, 515B. The application portion 620 is configured to rotate the flow of the RF power signal by 90 degrees and to match the (TE₁₀) mode of the RF signal to the TM₀₂-like mode within the TW accelerator structure 400.

For example, the particle source 535 injects a beam of charged particles (e.g., electrons, protons, or the like) into the first end 512 of the linac system 500. For example, the particle source 535 may emit a beam of charged particles along the beam path along the accelerator axis 402. The beam of charged particles enters the TW accelerator structure 400 via the first end 512 of the linac system 500 at a first energy with the beam of charged particles generally and/or substantially collimated along the accelerator axis 402. The beam of charged particles interacts with the accelerating electromagnetic field within the TW accelerator structure 400, which causes the beam of charged particles to accelerate and/or change energy as it travels along the beam path. The beam of charged particles exits the second end 514 of the linac system 500 (e.g., via an aperture of a closure end plate 425) at a second energy and is generally and/or substantially collimated along the accelerator axis 402. The second energy and the first energy are different from one another (e.g., not equal to one another). For example, in some instances, the second energy is larger than the first energy. In some instances, the second energy may be less than the first energy (e.g., the linac system 500 may be used to deaccelerate a particle beam, in an example embodiment).

In various embodiments, the beam of charged particles is focused as it travels along the beam path via a magnetic field generated by the outer rings 105 and/or end plates 125. In various embodiments, the linac system 500 comprises one or more directing components configured to direct or steer the beam of charged particles after the beam of charged particles exits the second end 514 of the linac system 500.

Many modifications and other embodiments of the disclosure set forth herein will come to mind to one skilled in the art to which the disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A linear accelerator comprising:
a plurality of cells, each cell comprising:
an outer ring, wherein the outer ring comprises a first material, wherein the first material is an electrically conducting material;
an inner ring centered within the outer ring, wherein the inner ring comprises a second material different from the first materials, wherein the second material is an electrically insulating material; and
an end plate, the end plate in physical contact with the outer ring and the inner ring and having a beam aperture therethrough;
wherein the beam aperture of each cell of the plurality of cells are aligned to define a beam path.

2. The linear accelerator of claim 1, wherein the space between the inner ring and the outer ring of each cell defines a respective outer cavity and the end plate further comprises a plurality of slots therethrough, the plurality of slots configured to couple the electromagnetic field within the respective outer cavity to a neighboring outer cavity.

3. The linear accelerator of claim 1, further comprising a radio frequency coupler configured to provide RF power into the plurality of cells.

4. The linear accelerator of claim 3, wherein, when the radio frequency signal is applied to the plurality of the cells, a radiofrequency field whose magnitude is larger in amplitude within the inner ring than in an outer cavity disposed between the inner ring and the outer ring.

5. The linear accelerator of claim 1, wherein the inner ring is positioned between the end plate and a neighboring end plate such that the outer ring and the inner ring are concentric.

6. The linear accelerator of claim 1, wherein the end plate comprises a third material, the first material and the third material are electrically conductive, and the second material is substantially electrically insulating.

7. The linear accelerator of claim 1, wherein the second material is a ceramic material.

8. The linear accelerator of claim 1, wherein the second material has a dielectric constant of at least 20.

9. The linear accelerator of claim 1, wherein the second material has a loss tangent less than 10⁻³.

10. The linear accelerator of claim 1, wherein the plurality of cells are clamped together in a linear arrangement.

11. The linear accelerator of claim 1, further comprising a particle source configured to provide particles to a first end of the beam path with a first energy, wherein the linear accelerator is configured to modify an energy of the particles along the beam path to cause the particles to exit a second end of the beam path with a second energy that is different from the first energy.

12. The linear accelerator of claim 1, wherein the end plate further comprises a groove configured to engage the inner ring.

13. The linear accelerator of claim 1, further comprising two or more clamping rods spaced about an exterior of a linear arrangement of the plurality of cells and configured to maintain the linear arrangement of the plurality of cells.

14. The linear accelerator of claim 1, further comprising a vacuum chamber configured to be coupled to a vacuum bellow, the plurality of cells disposed within the vacuum chamber.

15. The linear accelerator of claim 1, wherein the outer ring comprises a permanent magnet material.

16. The linear accelerator of claim 1, wherein the end plate comprises a domed central portion, the aperture formed through the domed central portion.

17. A linear accelerator comprising:
a plurality of cells, each cell comprising:
an outer ring, wherein the outer ring comprises a first material;
an inner ring, wherein the inner ring (a) comprises a second material that is substantially not conductive and (b) is centered within the outer ring; and
an end plate, the end plate in physical contact with the outer ring and the inner ring and having beam aperture therethrough;
wherein the beam aperture of each cell of the plurality of cells are aligned to define a beam path and the aligned plurality of cells are configured to support a higher order transverse magnetic mode of a radiofrequency signal.

18. The linear accelerator of claim 17, wherein the space between the inner ring and the outer ring of each cell defines a respective outer cavity and the end plate further comprises a plurality of slots therethrough, the plurality of slots configured to couple the electromagnetic field within the respective outer cavity to a neighboring outer cavity.

19. The linear accelerator of claim 17, further comprising a radio frequency coupler configured to provide RF power into the plurality of cells.

20. The linear accelerator of claim 17, wherein the first material is substantially electrically conductive and the second material is substantially electrically insulating.
